(19) United States
(12) Patent Application Publication
(10) Pub. No.: US 2015/0111162 A1
(43) Pub. Date: Apr. 23, 2015

(54) APPARATUS AND METHOD OF HEATING PLASTICS MATERIAL PRE-FORMS WITH MOTOR-CONTROLLED HOLDING ELEMENTS FOR THE PLASTICS MATERIAL PRE-FORMS

(71) Applicant: KRONES AG, Neutraubling (DE)

(72) Inventors: Gerald Huettner, Vilseck (DE); Klaus Voth, Obertraubling (DE)

(21) Appl. No.: 14/518,916

(22) Filed: Oct. 20, 2014

(30) Foreign Application Priority Data
Oct. 18, 2013 (DE) 10 2013 111 528.4

(51) Int. Cl. F27D 3/06; B29C 49/64

(52) U.S. Cl. CPC F27D 3/06; B29C 49/6409; B29K 2105/258
USPC 432/11; 432/239

(57) ABSTRACT

Described is an apparatus for the heating of plastics material pre-forms with a conveying device which conveys the plastics material pre-forms along a pre-set conveying path, wherein the conveying device (2) has a circulating conveyor, and a plurality of holding elements for holding the plastics material pre-forms arranged on this conveyor. The holding elements are movable with respect to a longitudinal direction (L) of the plastics material pre-forms to be rotated, and have associated with them in each case drive devices which are controllable independently of one another and which produce at least also the rotational movement of the plastics material pre-forms with respect to the longitudinal direction thereof.

The invention relates to an apparatus and a method of heating plastics material pre-forms. Apparatus and methods of this type have been known for a long time from the prior art. It is usual in this case for plastics material pre-forms first to be heated in these apparatus in order to be capable of being subsequently shaped in shaping devices, for example by means of a blow moulding wheel of a stretch blow moulding machine, to form plastics material containers, such as for example plastic bottles. In the case of furnaces of this type it is known for the plastics material pre-forms to be conveyed through heating tunnels or heating channels respectively by means of a conveying device, such as for example a conveying chain, and to be heated during this conveying. In this case it is also known in the prior art for the plastics material pre-forms to be rotated about their own longitudinal axis during this heating. In this way, a more uniform heating of the plastics material pre-forms can be achieved.

In the prior art this rotation is usually carried out by the plastics material pre-forms being coupled for example to a gear which runs past a stationary set of a gearing in order to achieve the rotation in this way. This procedure has proved successful, but is not satisfactory in all fields, in particular if a variable rotation of the plastics material pre-forms is desired for different reasons, for example if differences in rotation are to be produced or if for example the plastics material pre-forms are to be rotated in different ways. The latter has the advantage of being able to apply different or individual temperature profiles to the plastics material pre-forms.

The object of the present invention is therefore to increase the variability of apparatus of this type.

A further object underlying the invention is to provide an apparatus in which the vertical cams can be reduced, if possible.

These objects are attained according to the invention by the subjects of the independent claims. Advantageous embodiments and further developments form the subject matter of the sub-claims.

An apparatus according to the invention for the heating of plastics material pre-forms has a conveying device which conveys the plastics material pre-forms along a pre-set conveying path. In addition, the conveying device has a circulating conveying means, and a plurality of holding elements for holding the plastics material pre-forms are arranged on this circulating conveying means. In this case these holding elements are movable, in particular in a rotatable and/or displaceable manner, with respect to a longitudinal direction of the plastics material pre-forms to be rotated.

According to the invention these holding elements have associated with them in each case drive devices which are controllable independently of one another and which produce at least also the rotational movement of the plastics material pre-forms with respect to the longitudinal direction thereof.

While in the prior art the rotational movement of all plastics material pre-forms is produced in a uniform manner, for example by a belt drive, and the reciprocating movement of the plastics material pre-forms is produced by a vertical cam, it is now proposed that separate drive devices should be associated in each case with the individual holding elements. It is advantageous for these drive devices to have a stator and a rotor in each case. In this case it is advantageous for the stator of these drive devices to be arranged on the aforesaid conveying means. This conveying means can be for example a circulating chain or the like.

In addition, it is also possible for a stator of these drive devices to be incorporated in the conveying means, for example in the individual chain links of a conveying chain. It is advantageous for the holding element to be coupled to the rotor of the drive device, whereby in a particularly preferred manner the holding element is formed in one piece with this rotor.

It is advantageous for the holding element to be a holding mandrel which is capable of being introduced into an aperture of the containers or plastics material pre-forms respectively and which therefore holds the latter from the inside. It is preferable for the holding element to be coupled with the rotor.

In the case of a further advantageous embodiment the holding elements also have arranged on them in each case a screening element which screens off heat from those regions of the plastics material pre-forms which are not intended to be heated. In this case, in particular the threads or aperture regions of the plastics material pre-forms, should be protected.

In the case of a further advantageous embodiment the conveying path of the plastics material pre-forms has portions with different curvature. In this way for example, straight-line portions can be provided along which the plastics material pre-forms are conveyed as well as also curved portions. At these curved portions a direction of movement of the plastics material pre-forms can be reversed for example, i.e. the curved portions can have an overall angle of 180°.

In the case of a further advantageous embodiment the drive devices have in each case electric motors. In this case for example the stator of these electric motors can be arranged on the conveying means, such as a conveying chain, and the holding element for holding the plastics material pre-forms can in turn be arranged on the rotor.

It is thus preferable for the holding elements to be provided with electrical drives in each case. As mentioned, these can be electric motors in the conventional sense.

It is preferable, however, for these drive devices also to allow a movement of the holding elements in the longitudinal direction of the plastics material pre-forms. In this way, during the transfer of the plastics material pre-forms the holding mandrel can move, in particular, into the apertures of the plastics material pre-forms and can also be withdrawn out of the apertures of the plastics material pre-forms again at the end of the heating procedure. It is preferable for the drive device also to be a linear drive which also performs a rotational movement. In this case this linear drive can have a rotor and a stator, in which case the stator is preferably situated in a housing and is preferably arranged in a chain link.

As a result of an alteration of the movement speed in the longitudinal direction of the plastics material pre-forms, it is preferable for a temperature profile to be produced in the longitudinal direction of the plastics material pre-forms.

In the case of a further advantageous embodiment the apparatus has a cooling device for cooling the conveying means and/or the drive devices. In this way, a cooling device can be provided which causes a cooling of the conveying means and/or the drive device in an active or passive manner. By way of example, the conveying means can be designed in the form of a conveying chain with a plurality of chain links. In this case the individual chain links can be produced from metal, for example from aluminium, which is suitable for dissipating heat in an advantageous manner, in particular but not exclusively by way of cooling ribs. It is advantageous for the conveying means to be cooled by a gaseous medium, and in particular by cold air. The conveying means can also, however, be a rotatable wheel.

In addition, it would be possible for the cooling device to use a liquid for cooling. In this way for example, the heat produced by the drive device can be dissipated, for example with the aid of a blade which is arranged for example on the cooling ribs and which runs in a cooling liquid. In this way, the produced heat can also be dissipated by way of this cooling liquid.

In order to keep the infrared radiation of the heating devices further away, it is also possible for a screening device, such as for example a screening plate, to be provided below or between the conveying means and the individual heating devices, which can be in particular but not exclusively infrared radiators. In this case it is possible for each individual holding element and/or each individual holding device to have associated with it or them a screening device of this type. In this case it is also possible for these screening devices to be arranged individually on chain links of the conveying means. In addition, however, the conveying means could also be a circulating conveying belt or the like.

In the case of a further advantageous embodiment a stator of the drive device is cooled by way of the conveying means, and in particular by way of a chain link. As mentioned above, the conveying means is preferably produced from a metal, such as in particular aluminium. It would also be possible, however, for the conveying means to be produced from another material, and in particular from a plastics material.

In the case of a further advantageous embodiment a control device for the control of the drive devices is provided. It is preferable for each drive device to have a control device associated with it and it is particularly preferred for each drive device to have a separate current supply also. In this way for example, it can be provided for each holding element or each chain link respectively a separate current supply which can be implemented in a particularly preferred manner by way of sliding contacts. In this way, it is possible for example for a stationary carrier to be provided which is used for the current supply. In this case it would be possible for this carrier to have incorporated in it the supply means for two contacts or two poles respectively of the current supply.

In the case of a further advantageous embodiment the conveying means is, as mentioned above, a conveying chain.

In the case of a further advantageous embodiment each drive device has a decoder device, and in particular a digital decoder. This digital decoder is advantageously used to control the rotational speed and/or the stroke of the respective rotors of the individual drive devices. It is preferable for these individual digital decoders to be actuated by way of a control device. In this case it is possible for a control signal for actuating the digital decoders also to be supplied to the individual digital decoders by way of the current line mentioned above or another current line. In this way, it is preferably possible for control signals to be transmitted by way of a current consumption.

In the case of a further embodiment this digital decoder is arranged in a recess. In this way for example, a chain link can have a recess in which the aforesaid digital decoder is arranged.

In this case it is also possible for this digital decoder to be introduced into a depression and for this in turn to be preferably closed with a closure element, for example a plastics material compound.

In an advantageous manner between the digital decoder and the drive device, associated with the latter, it consists a connecting device, and in particular a line connection (such as for example a cable).

In this case this connecting line can be a plug-in connection (for example a socket or a wire), so that it is possible, for example for repair purposes, for the drive device to be removed from the conveying means, such as for example a chain link.

In addition, it would be possible for this digital decoder and the drive device also to be connected by way of a sliding contact and/or for the digital decoder to be connected to a sliding contact by way of a cable. In addition, it would be possible for each individual digital decoder which is associated in each case with a drive device to be controlled by a central control unit. In this case too, a control unit can again be provided, so that the decoder device is preferably also capable of being removable from the conveying means. In addition, it would also be possible, however, for each individual digital decoder to be actuated individually. In this way, different rotational speeds of the individual plastics material pre-forms can also be adjusted.

With respect to the rotation of the plastics material pre-forms as well, there is a relative degree of freedom on account of the invention. In this way, it would be possible for all the holding elements to perform repeated movements from a specified point of their circulation. In addition, as mentioned above, it would be possible for the rotational speeds or the rotational movements respectively of the individual holding elements to be different. In this case the rotational speeds and the rotational directions can also be different.

The holding elements for the plastics material pre-forms, or the rotors respectively, can be received in this case without lubricants. It is preferred for no guide cams to be used in order to initiate the rotational movement of the individual holding elements and/or in order to achieve a linear movement of the holding elements (in particular in a longitudinal direction of the plastics material pre-form[s]). In this way, these drives are preferably implemented without guide cams.

In the case of a further advantageous embodiment the apparatus has a current supply device—in particular arranged stationary—which supplies the drive devices with energy at least for a time. In this case it is possible for a suitable current rail, in particular a continuous current rail, to be provided on the circulating path of the conveying means, for example a chain-type running track. In this case it is possible for this current rail to have a plastics material carrier in which a copper track is formed for example. In addition, however, the current rail itself could also consist of copper and allow two supply means for current for example. Furthermore, this current supply device or current rail respectively could be angled from a material such as a metal sheet in such a way that it is self-supporting. It is preferable for the current supply device to be made continuous.

In addition, it would be possible for a suitable metal sheet current rail to be angled in such a way that it can be inserted into a plastics material carrier, for example into a bed of plastics material. It is therefore preferable for the aforesaid current rail to be inserted and, in particular embedded, into a plastics material carrier. It would now be possible for the apparatus to have at least one current pick-up which in operation is in permanent contact with the current rail or the conducting elements thereof respectively. In addition, it would be possible for a plurality of current pick-ups of this type to be present, in particular in the case of large heating devices.

In the case of a further advantageous embodiment the current supply device is arranged above the conveying means, for example above the chain links. In addition, it would also be possible for the current supply device to be situated behind the chain links or behind the conveying device respectively, or inside the circulating path of the conveying means respectively. In this way, the current supply device offers little obstruction in working operation. In addition, it would be possible for a holding element for contacting the current supply device—in particular during the movement of the holding elements—to be provided on at least one element of the conveying means, for example on a chain link. In this case it is preferred for a spring element to be provided which pre-stresses the contact means in the direction of the current consumption device.

In addition, it would be possible for already existing structures or current conveying elements respectively, to be used for the current supply. In this way, the current supply can be implemented in a region in which the driving energy or the control signals for the decoder for example are also transmitted. In addition, it would also be possible for use to be made of (current) conduction devices of this type, which are used for transmitting the drive energy and/or the control signals.

In the case of a further advantageous embodiment the drive devices are designed and/or controlled in such a way that they permit a rotational movement of the plastics material pre-forms at varying rotating velocities. It is preferred for each individual drive device also to have a control device for controlling a rotating velocity of the plastics material pre-forms. It is preferable for the control device to permit a periodic alteration of the rotating velocity of the plastics material pre-forms.

In the case of a further advantageous embodiment the apparatus also has at least one rotary position detection device which detects a rotary position of the plastics material pre-forms with respect to the longitudinal direction thereof. It is preferable for a rotating velocity to be controlled in a manner dependent upon this rotary position. In this way, a temperature profile of the heating can be produced in a circumferential direction of the plastics material pre-forms. It would thus be possible for example for the plastics material pre-forms first to be rotated a quarter turn at a first rotating velocity, then a quarter turn at a second velocity, then a further quarter turn again at the first velocity, and finally a further quarter turn at the second rotating velocity. In this case the second rotating velocity could be greater than the first rotating velocity. In addition, it would be possible for this rotating velocity to be continuously varied.

The present invention further relates to a method of heating plastics material pre-forms, in which the plastics material pre-forms are conveyed along a pre-set conveying path by at least one circulating conveying means and are heated during this conveying. In this case the plastics material pre-forms are arranged in each case on holding elements and during their heating they are moved with respect to their longitudinal direction at least for a time, and in particular are turned and/or displaced (in particular in a straight line).

According to the invention the plastics material pre-forms are turned by means of electric motor drives. It is preferable for the plastics material pre-forms also to be cooled at least for a time during their heating, and in particular to be cooled on their surfaces. This can be carried out for example by acting upon them with a cooling medium, such as in particular cooling air. In addition, further components of a corresponding apparatus are preferably also cooled, such as in particular drive devices and, in particular, the aforesaid electric motor drives.

In the case of a further advantageous method holding elements (or at least components of the holding devices such as the rotor mentioned above and/or the holding mandrel) for holding the plastics material pre-forms are also moved at least for a time along their longitudinal direction (which can also, however, be a longitudinal axis of the plastics material pre-forms). This is carried out in this case in particular to introduce these holding elements into the plastics material pre-forms and/or also to remove the holding elements from the plastics material pre-forms again. It is preferable for the plastics material pre-forms to be turned with respect to their longitudinal direction without the use of (in particular stationary) guide cams. It is also preferable for a movement of the holding element holding the plastics material pre-forms to be carried out without the use of (stationary) guide cams.

In the case of a further preferred method the rotary position of at least one holding element, more precisely one holding means which is a component of a holding device such as for example a holding mandrel, with respect to the longitudinal direction of the plastics material pre-forms is detected at least for a time. It is advantageous for the drive devices to be controlled in a manner dependent upon the detected rotary position.

In the case of a further advantageous method the rotating velocity of the plastics material pre-forms is altered at least for a time. In particular, the rotating velocity is altered at least for a time during the heating procedure. In this way, it would be possible for the rotating velocity to be altered at least periodically. It is particularly preferred for the rotating velocity also to be altered in a manner dependent upon a rotary position of the plastics material pre-forms.

It is preferable for the rotating velocity of the plastics material pre-forms to be altered in order to produce a temperature profile with respect to the wall of the plastics material pre-forms in the circumferential direction of the plastics material pre-forms in this way. This procedure can also be referred to as preferential heating. As a result, plastics material containers with a cross-section deviating from a circular cross-section, for example containers with an elliptical cross-section, can be produced more easily by means of a temperature profile of this type.

It is preferable for containers with a cross-section deviating from a circular cross-section to be produced subsequently to the heating procedure.

The present invention further relates to the use of the apparatus described above and/or the method described above for producing a temperature profile (preferential heating).

Further advantages and embodiments are evident from the attached drawings. In the drawings

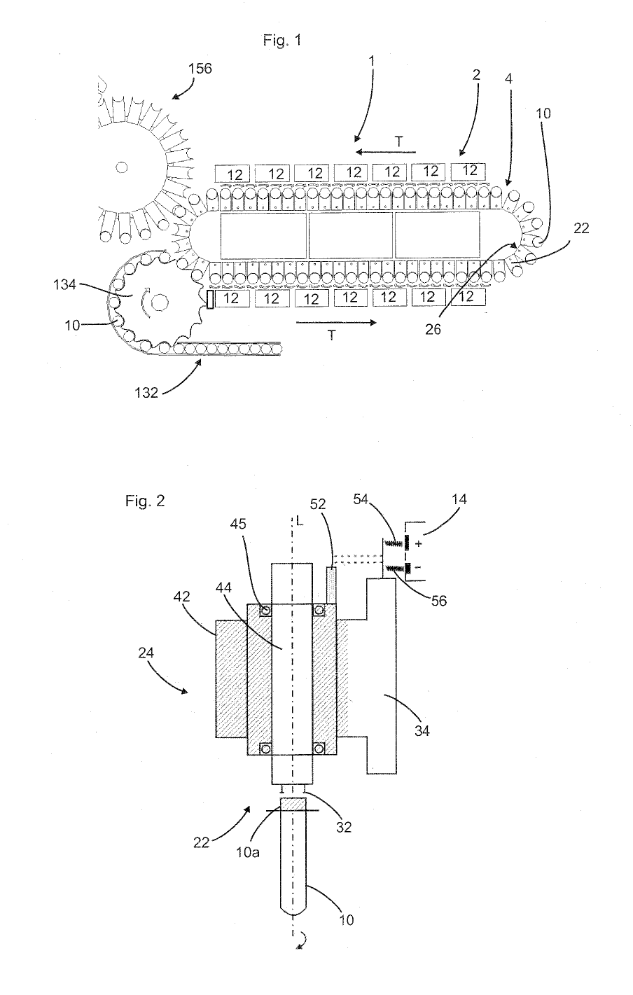

FIG. 1 is an illustration of an apparatus for heating plastics material pre-forms;

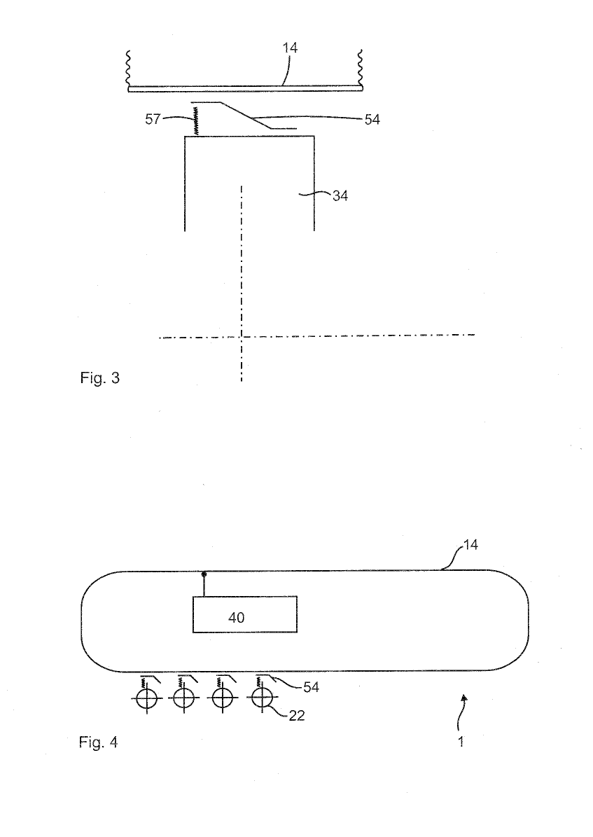

FIG. 2 is an illustration of an individual holding device for holding the plastics material pre-forms;

FIG. 3 is a diagrammatic plan view of the holding device according to FIG. 2;

FIG. 4 is a diagrammatic plan view of the apparatus according to FIG. 1;

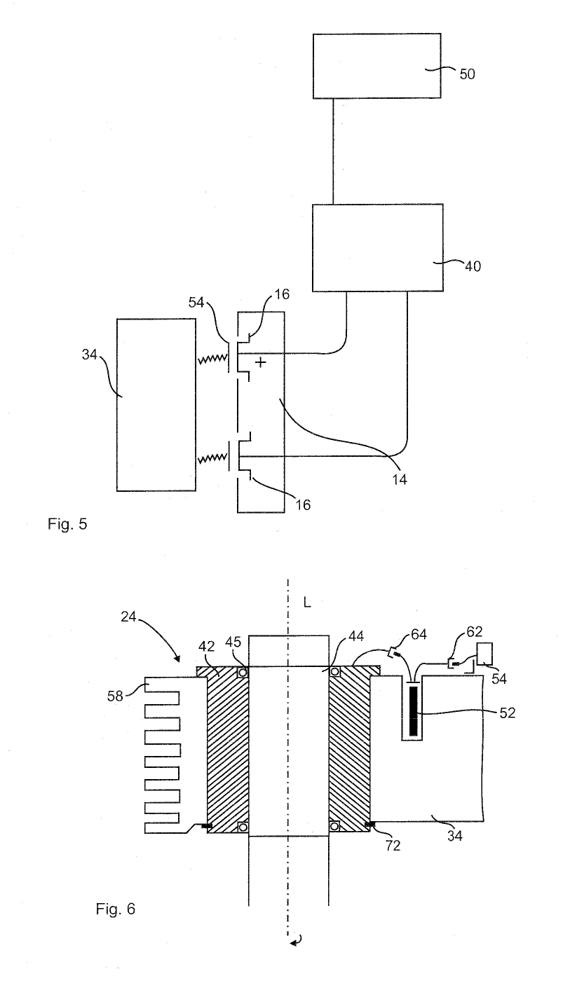

FIG. 5 is a diagrammatic illustration for the visualization of the activation;

FIG. 6 is a further diagrammatic illustration for the visualization of a holding device, and

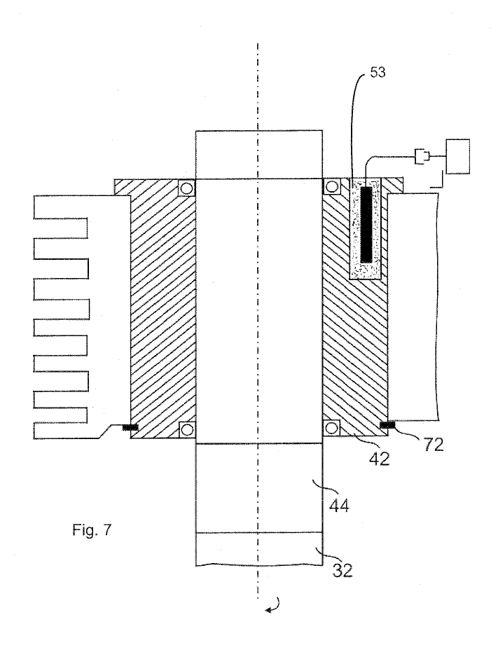

FIG. 7 is a further illustration of a holding device according to the invention.

FIG. 1 is a diagrammatic illustration of an apparatus 1 for the heating of plastics material pre-forms 10. In this case the plastics material pre-forms are first supplied to a single-break wheel or a separation device 134 respectively by way of a supply device 132 such as a supply rail. Starting from this separation device 134 the plastics material pre-forms are supplied to the actual linear furnace. This linear furnace has in this case a conveying device 2 which in turn has a circulating conveying means, such as a conveying chain 26, on which a plurality of holding devices 22 are arranged. These holding devices 22 are used in this case for holding the individual plastics material pre-forms in each case. The holding devices 22 have in this case holding elements 32 in each case (FIG. 2) which are designed in the form of holding mandrels here which engage in the apertures of the plastics material pre-forms.

The reference letter T designates a conveying path of the plastics material pre-forms. A plurality of heating devices 12 or warming devices respectively, which are used for heating the plastics material pre-forms, are arranged along this conveying path T. In addition, it is provided that the individual plastics material pre-forms 10 are rotatable about their longitudinal axis which in this case is at a right angle to the figure plane in FIG. 1.

The reference number 156 refers to a conveying device which transfers the plastics material pre-forms heated in this way to a shaping device (no longer shown) for shaping the plastics material pre-forms into plastics material containers.

FIG. 2 is a detailed view of a holding device 22. In this case the plastics material pre-form 10, which is held by means of a holding mandrel 32 which is introduced into its aperture 10a, is shown again.

The reference number 24 designates as a whole a drive device (such as in particular an electric motor) which in this case produces the rotation of the plastics material pre-form 10 with respect to its longitudinal axis L. This drive device 24 has in this case a stator 42 which is arranged on a chain link 34. A rotor 44, on which a holding mandrel 32 which is capable of being introduced into the aperture of the plastics material pre-forms is arranged in turn in a fixed manner, is provided so as to be rotatable with respect to this stator 42. The reference number 45 refers to bearing devices which are used for the rotatable bearing of the rotor 44.

The reference number 14 refers to a current supply device, such as a current rail which supplies the drive device 24 with current. In this case the drive device 24 has sliding contacts 54, 56 which slide along this current rail 14 or the respective contact strips. The reference number 52 refers to a digital decoder by which, in particular, a rotary position of the rotor of the drive device 24 can be detected, and optionally, however, also a position in the longitudinal direction of the plastics material pre-forms 10.

FIG. 3 is a plan view of the apparatus shown in FIG. 2. It is evident that in this case, in addition to the contact elements 56, pre-stressing devices 57 are also provided which clamp the contact elements to the current supply device 14. In this way, it is possible to ensure a reliable current flow to supply the drive device.

FIG. 4 is a further illustration of an apparatus 1 for the heating of plastics material pre-forms. In this case the circulating current supply device 14 is again illustrated, as well as also a control device 40 which controls the current supply to the individual drive devices 24. It is possible in this case for the drive devices of the individual holding elements to be actuated individually. It is also possible for each drive device of the holding elements to have a separate control device. It is preferable, however, for only one control device to be provided which controls all the drive devices of the holding elements.

FIG. 5 is an illustration for the visualization of the activation of the drive device. In this case a control device 40 is provided which is used to control the drive devices. This control device 40 can in turn be actuated by an overriding machine control means 50. The current supply device 14 has in this case two current rails 16 which are used in this case to supply the plus and minus contact. These current rails or the current supply device 14 respectively are or is made stationary in this case and the individual chain links 34, on which the holding devices 22 and thus also the holding elements are arranged, move relative thereto.

FIG. 6 is a further illustration of a holding device according to the invention. The chain link 34 is again evident in this case, which forms a recess in which the digital decoder device 52 is arranged. In this case plug-in contacts or plug socket combinations 62 and 64 are provided in order to release the connections to the drive device and also to the sliding contact 54 respectively.

The reference number 45 again refers to bearing devices. In addition, cooling devices 58 or cooling ribs respectively are provided which in this case allow a cooling of the drive device 24 or the stator 42 respectively and the rotor 44. The cooling is carried out in this case by the relative movement of the individual chain links 34. In this way, cooling ribs are provided on the chain link 34 in this embodiment.

The stator 42 can be dismantled by releasing the plug-in contact 64 and by releasing a retaining ring 72. The digital decoder device 52 is advantageously cast in a recess in the chain link or incorporated in the stator 42 generally in this case.

Finally, FIG. 7 shows a further embodiment of a holding device according to the invention. In this case too, a digital decoder 52 is again evident, which is connected to the sliding contact 54 by way of a plug-in connection. In the case of this design the digital decoder 52 is incorporated in the stator 42 of the drive device 40. The stator can be dismantled in this case by releasing the plug-in contact 62. The reference number 53 refers to a filling body such as for example a plastics material compound with which the digital decoder 52 is fastened in the recess.

The Applicants reserve the right to claim all the features disclosed in the application documents as being essential to the invention, insofar as they are novel either individually or in combination as compared with the prior art.

### LIST OF REFERENCES

L longitudinal direction
T conveying path
P conveying path
1 apparatus
2 conveying device
10 plastics material pre-form
10a aperture
14 current supply rail
12 heating devices/warming device
16 current rails
22 holding devices
26 conveying chain
30 cooling device
32 holding element, holding mandrel
34 chain link
40 control device
42 stator
44 rotor
45 bearing devices
52 digital decoder device
52 [sic] filling body
54 sliding contact
56 sliding contact
62 plug-in contacts/plug socket combinations
64 plug-in contacts/plug socket combinations
72 retaining ring
124 drive device
132 supply device
134 single-break wheel/separation device
156 conveying device

1. An apparatus for the heating of plastics material pre-forms with a conveying device which conveys the plastics material pre-forms along a pre-set conveying path, wherein the conveying device has a circulating conveyor, and a plurality of holding elements for holding the plastics material pre-forms are arranged on the conveyor, and the holding elements are movable with respect to a longitudinal direction (L) of the plastics material pre-forms to be rotated, wherein the holding elements have associated with them in each case drive devices which are controllable independently of one another and which produce at least also the rotational movement of the plastics material pre-forms with respect to the longitudinal direction thereof.

2. The apparatus according to claim 1, wherein the drive devices have in each case electric motors.

3. The apparatus according to claim 1, wherein the drive devices also allow a movement of the holding elements in the longitudinal direction (L) thereof.

4. The apparatus according to claim 1, wherein the apparatus has a cooling device for cooling the conveyor and/or the drive devices.

5. The apparatus according to claim 1, wherein the conveyor is a conveying chain.

6. The apparatus according to claim 1, wherein each drive device has a digital decoder.

7. The apparatus according to claim 1, wherein the apparatus has a current supply device which is arranged stationary and which supplies the drive devices with electrical energy at least for a time.

8. A method of heating plastics material pre-forms, wherein the plastics material pre-forms are conveyed along a pre-set conveying path (P) by at least one circulating conveyor and are heated during this conveying, wherein the plastics material pre-forms are arranged in each case on holding elements, and during their heating they are moved with respect to their longitudinal direction (L) at least for a time, wherein the plastics material pre-forms are turned by electric motor drives.

9. The method according to claim 8, wherein holding elements for holding the plastics material pre-foil is are also moved at least for a time along their longitudinal direction.

10. The method according to claim 8, wherein the rotary position of at least one holding element with respect to the longitudinal direction (L) is detected at least for a time.

11. The method according to claim 8, wherein the rotational speed of the plastics material pre-forms is altered at least for a time.
